(19) United States
(12) Patent Application Publication
(10) Pub. No.: US 2023/0270629 A1
(43) Pub. Date: Aug. 31, 2023

(54) DISPENSING CUP

(71) Applicant: Ares Trading S.A., Aubonne (CH)

(72) Inventors: Mike PATON, Melbourn Hertfordshire (GB); Theo KING, Melbourn Hertfordshire (GB); Darren SEYMOUR, Melbourn Hertfordshire (GB); Eric CHANIE, Aubonne (CH); Francesco PIRAS, Aubonne (CH)

(21) Appl. No.: 18/016,110

(22) PCT Filed: Jul. 2, 2021
(86) PCT No.: PCT/EP2021/068417

§ 371 Date: Jan. 13, 2023

(30) Foreign Application Priority Data
Jul. 15, 2020 (EP) 20186075.6

(51) Int. Cl. A61J 7/00; A61J 1/03; B65D 83/04; B65D 65/46; B65D 75/36; B65D 50/00; B65D 51/18; B65D 43/16

(52) U.S. Cl. CPC A61J 7/0046; A61J 1/035; B65D 83/0409; B65D 65/466; B65D 75/36; B65D 50/00; B65D 51/18; B65D 43/16; B65D 2251/0021; B65D 2251/0053; B65D 2251/1025; B65D 2251/105; B65D 2583/005; B65D 2543/00148

(57) ABSTRACT

Described herein is dispensing cup for use with medicaments, which dispensing cup in use allows for the patient to (self) administer an oral medicament (tablet or capsule) without the need to come into direct (skin) contact with such medicament.

### FIELD OF THE INVENTION

The present invention relates to a dispensing cup. The dispensing cup can dispense medication from a medication container into the cup for dispensing to a patient without the patient having to handle or touch the medication while taking the medication orally.

### BACKGROUND

Certain products are potentially harmful to human through exposure of the skin to substances in such products. These substances may be cytotoxic and humans should avoid touching or otherwise handling such substances which results in exposure of the human skin to such substances. Medications and medicaments are designed to provide treatment to a patient in the form of a treatment of the symptoms, disease or disorder. Such medicaments are tested for safety and efficacy prior to being approved as medication/drug to be available to the patients. Frequently the potential risks of the medicament are weighed against its potential benefits. As such certain medicaments/drugs can be approved in a treatment for a particular disorder while at the same time include some safety risks.

Accordingly, some medicaments/drugs can be cytotoxic and patients may want to minimize exposure to the skin by touching while taking (administering) such medicament/drug orally. Exposure to the human skin can be reduced by using (surgical) gloves when handling the medicament and remaining residue on surfaces potentially touches by such medicament could be prevented by covering such surfaces prior to opening a packaging containing such medicament. Thus, patients may opt to wear protective gear such as gloves and cover a working space for opening a packaging with disposable material or may choose to do both. These options are cumbersome to the patient and increase resistance to adhering to a treatment regimen with such a medication/drug from which the patient would benefit.

What is needed, specially for tablet and capsule formulations of a medicament/drug, is a presentation of the medication/drug which would provide a method for easy handling of the medication/drug while allowing that the patient does not have to be in direct contact with one of such medicaments/drugs. Currently, the patient has to resort to such cumbersome procedures as described above. Accordingly, there is a need to provide a device and/or method which is easy to use and allows the patient to dispense and take (administer) a medicament/drug without having to have direct contact with the medicament/drug in the form of a tablet or capsule.

In addition, considering the potential risk such medicaments/drugs pose it is often important that children have no easy access to such medicaments/drugs. The regulatory authorities, being sensitive to these concerns, often require the presentations of the medicament/drug which are child resistant.

Thus, there is a need to provide such device and/or method which is easy to use and allows the patient to access the medicament/drug without having to come in direct contact it. There is a further need that such device is also child resistant to prevent easy access by a child to such medicament/drug.

### SUMMARY OF THE INVENTION

The current invention provides a solution to the above described problems by providing a device which allows a patient to easily access any medicament/drug in a tablet or capsule container which does not require the patient to come into direct contact with the tablet or capsule. The device is a dispensing cup which includes a cup body into which a tablet or capsule can be collected from a medicament/drug container (such as a tablet or capsule container). Once collected into the cup body the medicament/drug (tablet or capsule) can be taken (administered) orally through an opening in the dispensing cup. Such dispensing cup of the present invention allows handling of the medication by the patient without the need for the patient to have direct contact with the medication. The dispensing cup can have child resistant features to prevent easy access to any medication by a child.

In one embodiment, the present invention provides a dispensing cup comprising; a cup body, an opening for dispensing one or more tablets to a patient, and a tablet or capsule container, wherein the cup body is configured to collect the one or more tablets or capsules from the tablet or capsule container prior to dispensing to the patient whereby removal of the one or more tablets from the tablet container does not require the patient to come into direct contact with the one or more tablets while dispensing.

In another embodiment, the present invention provides a dispensing cup comprising; a cup body, an opening for dispensing one or more tablets to a patient, and a tablet or capsule container, wherein the cup body is configured to collect the one or more tablets or capsules from the tablet or capsule container prior to dispensing to the patient whereby removal of the one or more tablets from the tablet container does not require the patient to come into direct contact with the one or more tablets while dispensing, and the dispensing cup further provides a child resistant securing means.

In yet another embodiment there is provided a method of administering a tablet or capsule to a patient without coming into direct contact with such tablet or capsule by using a dispensing cup of the present invention.

### BRIEF DESCRIPTION OF THE DRAWINGS

FIG. 1: Shows a dispensing cup of the present invention. The dispensing cup being useful with either a tablet or a capsule container. The dispensing cup shows a cup body, a tablet or capsule container and an opening for dispensing a tablet or capsule to a patient as shown in FIG. 1A.

FIG. 1B shows more detail relating to the dispensing cup.

FIG. 2: Shows a dispensing cup of the present invention including child resistant features in the form of squeeze tabs. FIGS. 2A and 2B show two alternatives of such dispensing cup with squeeze tabs as child resistant features. FIG. 2C includes an alternative embodiment wherein the child resistant securing means includes an additional tab or tabs which engage with a rim of the opposing part of the dispensing cup. FIG. 2D shows an additional alternative wherein the opening is covered with a peelable label.

FIG. 3: Shows a dispensing cup of the present invention including child resistant features in the form of a sliding sleeve which covers the cup body, tablet or capsule container and the opening of the dispensing cup.

FIG. 4: Shows a dispensing cup of the present invention including an alternative sliding sleeve as a child resistant feature for the dispensing cup. In this alternative embodiment the sliding sleeve is between the open cup and the cup lid comprising the tablet or capsule container and prevents in closed position the removal of tablets or capsules from the container into the open cup. FIG. 4A shows the position of the child securing means in the dispensing cup while in FIG. 4B a progression is shown from closed (preventing dispensing tablets or capsules) to open (allowing dispensing tablets or capsules into the cup) to the closed position (which allows dispensing from the open cup to the patient). FIG. 4C shows an additional feature of the sliding sleeve embodiment which includes a tab which secures the sliding sleeve when in a closed position.

### DETAILED DESCRIPTION OF THE INVENTION

As certain medications recommend careful handling by the patient when administering or self-administering such a medicament/drug it may increase a patient's anxiety. Such patient may use an elaborate method of removing the medicament/drug from the packaging and administering such medication (orally) while being careful not to touch the medicament/drug. Such increased patient anxiety may also lead to a decrease in adherence. Some medicaments/drugs however do require special care as they may be cytotoxic and exposure to the human skin is recommended to be minimized. The present invention provides a solution which is easy to use and allows the patient to avoid direct skin contact with the medication while administering or self-administering the medicament/drug. A dispensing cup as in the present invention allows the patient to avoid direct skin contact with the medicament/drug while administering or self-administering. The dispensing cup is easy to use. As a result, patient experience while taking the medicament/drug is improved and at the same time may increase adherence to a treatment regimen with such medicament/drug.

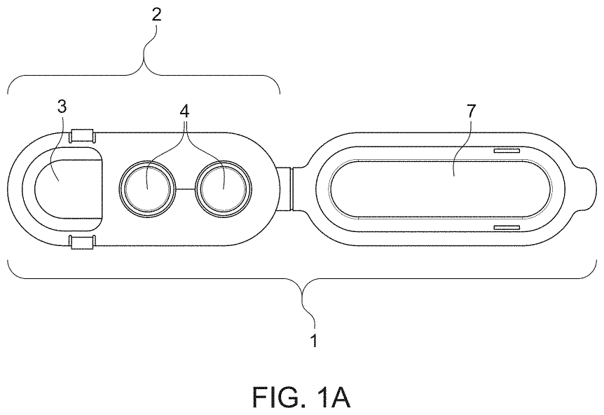

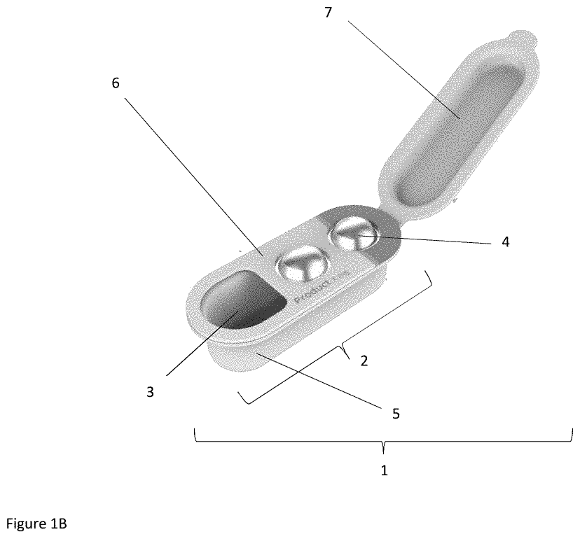

The dispensing cup of the present invention as shown in FIG. 1 is easy to use and allows dispensing a medicament/drug to a patient through an opening (3) in the dispensing cup (1) without the patient to have direct contact (skin contact) with the medicament/drug. FIG. 1 shows one embodiment of the present invention. Shown is a dispensing cup (1) comprising a cup body (2), an opening (3) for dispensing one or more tablet or capsules to a patient and a tablet or capsule container (4). The cup body (2) is configured to collect the one or more tablets or capsules from the tablet or capsule container (4) prior to dispensing such medicament/drug to the patient. The removal of the one or more tablets or capsules from the tablet or capsule container (4) does not require the patient to come into direct contact with the one or more tablets or capsules while dispensing (and administering or self-administering) to the patient.

In the dispensing cup (1) as shown in FIG. 1 or any of the alternative embodiments as described in the present invention the cup body (2) can comprise an open cup (5) and a cup lid (6) as shown in FIG. 16. In certain embodiments the cup lid (6) is configured to receive the tablet or capsule container (4). Such configuration allows for the dispensing cup (1) of the present invention to receive a pre-packaged tablet or capsule in a tablet or capsule container (4) within the cup body (2). Such pre-packaged one or more tablets or capsules can be in the form of any packaging configuration that is compatible with the cup lid (6). An example of such pre-packaged one or more tablets or capsules is in the form of a blister pack. Such blister pack as tablet or capsule container (4) for the one or more tablets or capsules is received within the cup lid (6) of the cup body (2). The cup lid (6) having received the tablet or capsule container (4) and when closed is at least partly covering the open cup (5) of the cup body (2). As such the closed cup lid (6) leaves open the opening (3) for dispensing the one or more tablets or capsules. Alternatively, the cup lid (6) further includes an opening and when closing onto the open cup (5) leaves an opening (3) for dispensing the one or more tablets or capsules. The use of a cup lid (6) to receive prepackaged tablets or capsules in a tablet or capsule container (4) may significantly simplify manufacturing of the dispensing cup device as the manufacturing of the dispensing cup (1) does not require direct handling of the tablets or capsules.

In alternative embodiments of the present invention and as shown in FIG. 16 the dispensing cup (1) of the present invention further comprises a cover (7). This cover (7) can enclose the entire top part of the cup body (2) thereby covering the cup lid (6) and tablet or capsule container (4) and opening (3) as is shown in FIG. 16. As such cover (7) protects the one or more tablets or capsules in the tablet or capsule container (4) and the covers the opening (3) of the dispensing cup (1). The interior space of the cup body (2)/open cup (5) is also protected from being exposed thereby reducing the accumulation of unwanted substances. Moreover, cover (7) also could protect access to the tablets or capsules by children and as such present one alternative method of securing that the dispensing cup (1) includes child resistant features. Alternative methods for child resistant features, even those without a cover (7) are discussed below.

The dispensing cup (1) may be manufactured and include the tablet or capsule container for a single dose of the treatment regimen. As such the dispensing cup (1) of the present invention can integrate the tablet or capsule blister packaging into a pre-packaged solution for the patient. Such pre-packaged solution includes one or more doses according to the treatment regimen. The dispensing cup of the present invention can be designed for either single use or multiple use (through recycling of the dispensing cup) for receiving another pre-packaged tablet or capsule container.

To reduce packaging waste as a result of the solution as provided by the present invention one or more or all parts of the dispensing cup (1) of the present invention can be produced from disposable materials. Optionally such disposable materials are biodegradable materials.

The dispensing cup (1) of the present invention optionally includes a connectivity means. Such connectivity means allows interaction with external solutions or communication with external or remote devices. One example of such connectivity means includes the presence on the dispensing cup (1) of a QR code or similar scannable code (for example a bar code) which allows information to be obtained from a remote device on a smart device or enabled device of the patient. Another example includes a RF tag or other wireless element to be present on the dispensing cup of the present invention for connection with an external device. Yet another example includes a loyalty card or code to be used by the patient for accessing information on a remote device.

Considering that the tablets or capsules are potentially harmful to children the dispensing cup (1) of the present invention in alternative embodiments further includes a child resistant securing means. Such child resistant securing means prevents easy access to the one or more tablets or capsules by children. The child resistant securing means can be part of the cover (7) or in alternative embodiments include means which prevents in one configuration the removal of the one or more tablets or capsules from the tablet or capsule container (4).

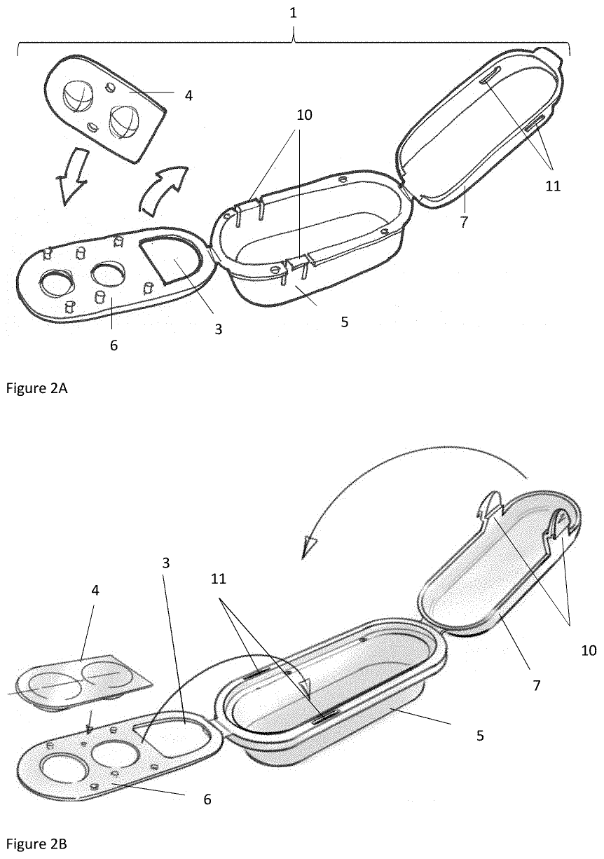

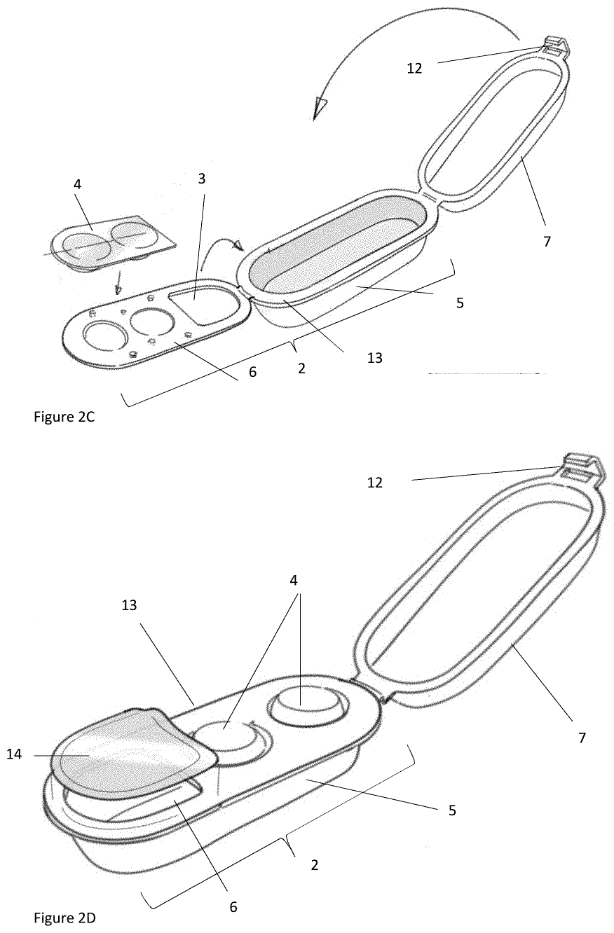

In one such embodiment of a child resistant securing means for the dispensing cup (1) as shown in FIG. 2, the child resistant securing means comprises one or more tabs (10) and one or more slits (11) on opposing parts of the dispensing cup, wherein the opposing parts are the open cup (5) (as part of the cup body) and the cover (7) (See FIGS. 2A and 2B). The one or more tabs (10) engage with the one or more slits (11) on the corresponding opposing part of the dispensing cup. In a closed or secured position the tabs (10) are engaged with the slits (11) and require manipulation to release the tabs (10) from the slits (11). In instances where the child resistant securing means includes more than one such tabs (10) and corresponding slits (11), simultaneous manipulation is required to release the tabs (10) from the slits (11) in order to open the dispensing cup of the present invention.

In one embodiment where the child resistant securing means includes tabs (10) and corresponding slits (11) on opposing parts of the dispensing cup (1), the one or more tabs (10) are located on the open cup (5) (of the cup body) and the corresponding slits (11) are located on the cover (7) as shown in FIG. 2A. Alternatively, as shown in FIG. 2B one or more tabs (10) are present on the cover (7) and the corresponding slits (11) are present on the open cup (5) (of the cup body). Alternative embodiments are also possible which are a mixture between the two above described alternative embodiments wherein some but not all of the one or more tabs (10) are present on the open cup (5) or cup body (2) and the remaining one or more tabs (10) are present on the cover (7), the corresponding slits (11) being present on the opposing part, either the open cup (5) or the cup body (2) or cover (7), of the dispensing cup (1). Alternatively, the one or more tabs (10) do not engage with a slit (11) on an opposing part but engage with the rim (13) of the opposing part of the dispensing cup (1). For example in any of the here before described embodiments the child resistant securing means comprises an additional one or more tab (12) on either the cup body (2) (or open cup (5)) or cover (7) and which engages with a rim (13) on the opposing part (i.e. the opposing cover (7) or cup body (2) (or open cup (5))) as shown in FIG. 2C. As described above such one or more tabs (12) which engage with the rim (13) on the opposing part of the dispensing cup can be the only securing means of the cover (7) to the cup body (2).

Further, the child resistant securing means in an alternative embodiment may comprise a removable film (14) (peelable label) which covers the opening (3) of the dispensing cup (1) as is shown in FIG. 2D. Such removable film (14) as a child resistant securing means also serves to protect the interior of the cup body (2) from unwanted substances. The removable film (14) can be the only child resistant securing means or can be in combination with any other child resistant securing means as described herein.

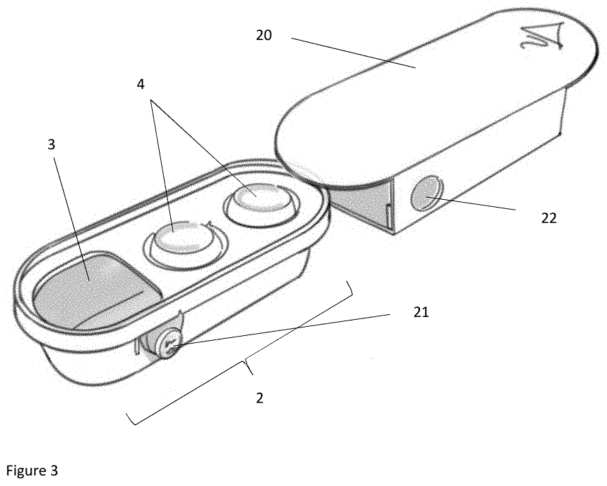

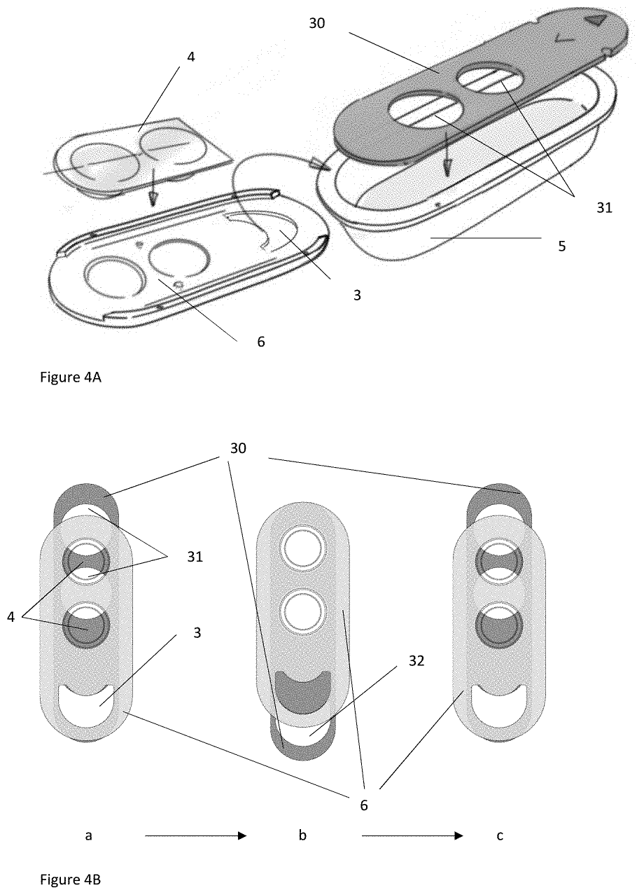

FIG. 3 shows an alternative embodiment for a child resistant securing means which comprises a sliding sleeve (20). The sliding sleeve (20) covers the entire dispensing cup (1) or only part thereof. The sliding sleeve (20) further comprises one or more openings (21) which engage with one or more tabs (22) on the cup body (2) when in a secured position. Release of the sliding sleeve (20) requires manipulation, either simultaneously or in following order, of the one or more tabs.

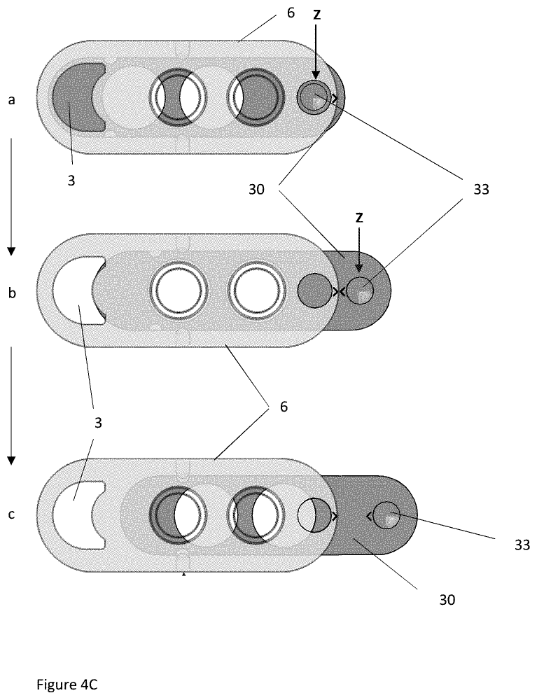

The child resistant securing means in an alternative embodiment is present between the cup lid (6) and open cup (5) as is shown in FIG. 4. In such embodiment there is present a sliding sleeve (30) between the cup lid (6) and open cup (5) which at least partly covers any openings on the tablet or capsule container (4) in a closed configuration and which sliding sleeve (30) further comprises one or more openings (31) which in a closed configuration are not aligned with any openings on the tablet or capsule container (4) as is shown in FIG. 4A. In an open configuration the one or more openings (31) are aligned with any openings on the tablet container (4) and when placed in such position the openings on the tablet or capsule container (4) can release one or more tablets or capsules from the tablet or capsule container (4) into the open cup (5). In one embodiment the sliding sleeve (30) when misaligned (i.e. in a closed position) only covers any openings on the tablet or capsule container (4). In another embodiment the sliding sleeve (30) also includes an opening (32) for the opening (3) of the dispensing cup an example of which is included in FIG. 4B. In one position of the sliding sleeve (30) its opening (32) is misaligned and covers opening (3) of the dispensing cup of the present invention thereby preventing access (by a child) to any tablet or capsule in the open cup (5) of the cup body of the dispensing cup.

FIG. 4B shows one set up in which the sliding sleeve (30) (under cup lid (6)) moves through different configurations to either close or open positions for releasing one or more tablets or capsules into the open cup or from the open cup to the patient. In configuration (a) the one or more openings (31) of the sliding sleeve (30) are misaligned with any openings on the tablet or capsule container (4). In such position the one or more tablets or capsules cannot be released from the tablet container (4) into the open cup. In this configuration (a) opening (32) on the sliding sleeve (30) (if present) can be aligned with opening (3) as no tablet(s) or capsule(s) can be released into the open cup. Sliding of sliding sleeve (30) to arrive at configuration (b) results in the alignment of openings (31) of the sliding sleeve (30) with any opening on the tablet or capsule container (4). In such configuration the one or more tablets or capsules can be released from the tablet container into the open cup. The sliding sleeve (30) can cover (or partly cover) opening (3) preventing access to the one or more tablets or capsules in the open cup. In configuration (c) the sliding sleeve (30) has again been slid again in a position wherein the one or more openings (31) of the sliding sleeve (30) are misaligned with respect to any openings on the tablet container (4). However, opening (3) is in this configuration open, either because alignment of opening (32) with opening (3) or because sliding sleeve (30) does not cover or obstruct opening (3) in this position, and the patient has access to the one or more tablets or capsules for administering or self-administering the medication.

A similar progression through configurations (a) to (c) is shown in FIG. 4C. In addition, the sliding sleeve (30) can further comprise a securing means (33) for securing the sliding sleeve (30) in closed configuration as is shown in FIG. 4C. The securing means (33) is optionally one or more buttons or tabs which engage with the cup lid (6) of the dispensing cup (1). In FIG. 4C one such example is shown wherein the sliding sleeve (30) comprises a button which engages with the cup lid (6). Depression of the button (33) in direction (Z) (as shown in FIG. 4C(a) and (b)) releases the sliding sleeve (30) from its locked and misaligned position. The patient can slide the sliding sleeve (30) to an aligned position in which position all openings on the sliding sleeve (30) are aligned with corresponding openings on the tablet or capsule container (4) and/or the opening (3) of the dispensing cup (as shown in FIG. 4C (b) and (c)).

The dispensing cup of the present invention can be used with any pharmaceutical composition. The dispensing cup of the present invention is particularly useful for a tablet or capsule formulations which comprises an active pharmaceutical ingredient which is potentially harmful to the patient when contacted directly by human skin and/or has cytotoxic properties. An example of such active pharmaceutical ingredient is cladribine.

The present invention further provides a method of administering or self-administering to a patient a tablet or capsule without directly contacting the tablet or capsule using a dispensing cup as described herein. Such method is particularly useful when the tablet or capsule to be administered or self-administered is potentially harmful to direct contact with human skin and/or cytotoxic such as for example tablets or capsule which comprise cladribine as the active pharmaceutical ingredient.

1. A dispensing cup (1) comprising
a. a cup body (2),
b. an opening (3) for dispensing one or more tablets to a patient, and
c. a tablet container (4),
wherein the cup body (2) is configured to collect the one or more tablets from the tablet container (4) prior to dispensing to the patient whereby removal of the one or more tablets from the tablet container (4) does not require the patient to come into direct contact with the one or more tablets while dispensing.

2. The dispensing cup of claim 1, wherein the dispensing cup (1) is disposable.

3. The dispensing cup of any preceding claim, wherein the tablet container (4) is a blister container for one or more tablets.

4. The dispensing cup of any preceding claim, wherein the cup body (2) comprises an open cup (5) and a cup lid (6), wherein the cup lid (6) is configured to receive the tablet container (4).

5. The dispensing cup of claim 4, wherein the cup lid (6) when closed is partly covering the open cup (5) leaving the opening (3) for dispensing one or more tablets.

6. The dispensing cup of any preceding claim, further comprising a cover (7).

7. The dispensing cup of any preceding claim, wherein a child resistant securing means is present to prevent easy access to the tablets.

8. The dispensing cup of claim 7, wherein child resistant securing means comprises one or more tabs (10) and one or more slits (11) on opposing parts of the dispensing cup, wherein the opposing parts are the cup body (2) or open cup (5) and the cover (7) and wherein the one or more tabs (10) engage with the one or more slits (11) on the corresponding opposing part of the dispensing cup.

9. The dispensing cup of claim 8, wherein the child resistant securing means comprises an additional tab (12) on one opposing part of the dispensing device, which tab (12) engages with a rim (13) on the opposing part of the dispensing cup.

10. The dispensing cup of any preceding claim, wherein the opening (3) is covered with a removable film (14).

11. The dispensing cup of claim 7, wherein the child resistant securing means comprises a sliding sleeve (20) covering one or more of the cup body (2), the opening (3), and the tablet container (3) and further comprising one or more tabs (21) on the cup body (2).

12. The dispensing cup of claim 7, wherein a child resistant securing means is present between the cup lid (6) and the cup body (2) and wherein the child resistant securing means comprises a sliding sleeve (30) which at least partly covers any openings on the tablet container (4) in a closed configuration and which sliding sleeve (30) further comprises one or more openings (31) which in a closed configuration are not aligned with any openings on the tablet container (4) and in an open configuration are aligned with such openings on the tablet container (4), wherein the openings on the tablet container release one or more tablets from the tablet container into the cup body (2) or open cup (5).

13. The dispensing cup of claim 12, wherein the sliding sleeve (30) in a closed configuration covers opening (3).

14. The dispensing cup of claim 12 or 13, further comprising a securing means (33) for securing the sliding sleeve (30) in a closed configuration.

15. The dispensing cup of any preceding claim, wherein one or more of the cup body (2), the tablet container (4), the cup lid (6) and the cover (7) are of a biodegradable material.

16. The dispensing cup of any preceding claim, further comprising a connectivity means.

17. The dispensing cup of any preceding claim, wherein the tablet comprises an active pharmaceutical ingredient which is potentially harmful to the patient when contacted directly by human skin.

18. The dispensing cup of claim 17, wherein the active pharmaceutical ingredient is cladribine.

19. A method of administering a tablet to a patient without directly contacting the tablet using a dispensing cup of claims 1 to 18.
